(19) United States
(12) Patent Application Publication
(10) Pub. No.: US 2011/0297308 A1
(43) Pub. Date: Dec. 8, 2011

(54) METHOD OF MAKING AUTOMOTIVE BODY PARTS

(76) Inventors: Stephen Paul Makin, Buford, GA (US); Donald E. Panoz, Hoschton, GA (US)

(21) Appl. No.: 13/152,617

(22) Filed: Jun. 3, 2011

Related U.S. Application Data
(60) Provisional application No. 61/352,749, filed on Jun. 8, 2010.

(51) Int. Cl. B29C 70/34

(52) U.S. Cl. 156/245; 264/571

(57) ABSTRACT

An automotive body part, such as a body frame or side impact protection system, is prepared from a thermoplastic composite in a pressure vessel at pressures between about 1 and 6 bar and a temperature less than about 285° F.

This application claims the benefit of U.S. patent application Ser. No. 61/352,749, filed on Jun. 8, 2010, herein incorporated by reference.

### FIELD OF THE INVENTION

The invention relates to a method of making an automotive body, such as a body frame or side impact protection system, using a thermoplastic composite.

### BACKGROUND OF THE INVENTION

Thermoplastic composites have been proposed for use in the molding of automotive body parts and other shaped articles since such composites exhibit high impact resistance and stiffness and are lightweight. One such material is a polypropylene thermoplastic composite which is composed of tape yarn and which has a highly-drawn core within a melt polymer matrix. Exemplary of such composites is TEGRIS® LM, a product of Milliken & Company.

Efforts to manufacture automotive body parts and other lightweight articles from such thermoplastic composites have not been successful. For instance, such composites have been seen to be unsuccessful for prototyping and low production runs. In addition, intricately shaped parts cannot be formed using such techniques. Normally when heated platen presses, stamping and die molds have been used such methods require extreme set up costs.

Attempts to produce shaped articles comprising thermoplastic composites by introducing the composite into a vacuum bag autoclave have not been successful. In order to form molded products successfully by vacuum, heat and/or pressure is required. To date, pressure vessel technology (autoclave) has been utilized for prototyping and medium to low production runs. However, thermoplastic body parts from such processes are often unusable due to lack of bond consolidation. In addition, intricately shaped parts have been proven to be difficult to manufacture using such processes.

Efforts have therefore been sought which will counter the morphing properties of such thermoplastic composites during autoclave methods.

### SUMMARY OF THE INVENTION

Body parts for automotive vehicles may be prepared in accordance with the invention wherein at least a portion of the body part is made of a thermoplastic composite. In a preferred embodiment, the preferred thermoplastic is polypropylene fabric which offers excellent impact resistance and stiffness to the manufactured body part. Most preferred are polypropylene tape yarns having a highly-drawn core and which exhibit a lower melt polymer matrix for composite processing as well as those polypropylene tape yarns which are recyclable.

The process uses a pressure vessel and may utilize single or multi-cure techniques and is conducted at pressures less than 6 bar and at a temperature between less than 290° F., preferably between from about 280° F. to about 285° F. The process eliminates the need for expensive presses, tooling and further reduces energy costs, resulting in very high profit margins for production runs.

The manufacturing process defined herein produces integrally shaped body parts which are not distorted. In addition, being lightweight, the resulting manufactured body party is ideal for use in racing cars. In addition to the automotive industry, the process described herein may also be used in other industries which require production of products which are lightweight, have high strength and anti-corrosive properties and desire recycleability. The process may further be used in other tooling, such as carbon fiber molding, fiber glass, wood and any other material that can withstand up to 6 bar pressure at less than 290° F.

### BRIEF DESCRIPTION OF THE DRAWINGS

In order to more fully understand the drawings referred to in the detailed description of the present invention, a brief description of each drawing is presented, in which:

FIG. 1 represents an embodiment of the invention showing an automotive body part prior to curing which contains a thermoplastic composite for use in manufacturing side impact protection systems of an automotive vehicle.

FIG. 2 shows a representative curing cycle for manufacture of a side impact protection system described herein.

FIG. 3 sets forth an embodiment of the invention for manufacturing an automotive body part wherein a thermoplastic composite, bonding layer and carrier resin with a reinforcing material (such as graphite or carbon fibers) are incorporated into a mold.

FIG. 4 shows an embodiment of the invention for manufacturing an automotive body part wherein a thermoplastic layer, bonding layer and multiple layers of a carrier resin with reinforcing materials are incorporated into a mold.

FIG. 5 shows a representative curing cycle for manufacture of a shaped article made with a thermoplastic composite and a carrier resin containing a reinforcing material such as graphite or carbon fibers.

FIGS. 6 and 7 show a body part manufactured from multiple layers including a thermoplastic composite, core, bonding film and outer skin.

FIG. 8 shows an embodiment of the invention for manufacturing an automotive body part which contains a thermo expanding intensifier.

FIG. 9 shows a representative curing cycle for the manufacture of a body part containing thermoplastic composite, core, bonding film and outer skin.

FIG. 10 illustrates assembly of multiple body parts in an assembly mold.

FIG. 11 illustrates a body part manufactured from three different molds.

### DETAILED DESCRIPTION OF THE PREFERRED EMBODIMENTS

Suitable thermoplastic composites are those containing axially drawn tape fibers. In a preferred embodiment, the thermoplastic composite is comprised of one or more mat layers of interwoven axially drawn tape fiber elements, optionally with non-olefin embedded fiber elements anchored within the mat structure. The non-olefin embedded fiber elements may operate alone or in conjunction with one or more non-olefin surface layers to define a substantially secure bondable surface structure in layered relation relative to at least a portion of the mat structure.

In another embodiment, the thermoplastic composite is a mat structure formed from axially drawn tape fiber elements that incorporate a central or base layer of a strain oriented polymer and at least one covering layer of a heat fusible polymer. The covering layer of the tape fiber elements is characterized by a softening point below that of the base layer to permit fusion bonding upon application of heat. A multiplicity of embedded non-olefin fiber elements extends in anchored relation at least partially across the thickness dimension of the mat structure such that at least a portion of the fiber elements project outwardly from the mat structure and the projecting portions define at least a partial surface covering across the mat structure. The composite of the mat with anchored non-olefin fiber elements is moldable to a three-dimensional geometry by application of heat and pressure following formation.

In another embodiment, the mat structure is formed from axially drawn tape fiber elements incorporating a central or base layer of a strain oriented polymer and at least one covering layer of a heat fusible polymer. The covering layer of the tape fiber elements is characterized by a softening point below that of the base layer to permit fusion bonding upon application of heat. A multiplicity of embedded non-olefin fiber elements extends in anchored relation at least partially across the thickness dimension of the mat structure and one or more non-olefin surface layers such that at least a portion of the fiber elements project outwardly from the surface layers and the surface layers in combination with the projecting portions define at least a partial covering across the mat structure. The composite of the mat with anchored non-olefin fiber elements and non-olefin surface layers is moldable to a three-dimensional geometry by application of heat and pressure following formation.

Suitable polypropylene composites include all of those disclosed in U.S. Pat. No. 6,300,691 and U.S. Pat. No. 5,466,503, both of which are herein incorporated by reference.

Exemplary composites include those containing multilayers of polymeric film having a substrate or core layer disposed between surface layers. Alternatively, only a single surface layer may be present, thereby resulting in a construction of a core layer being adjacent to surface layer. The film may be cut into a multiplicity of longitudinal strips of a desired width. The film may then be drawn to increase the orientation of the core layer so as to provide increased strength and stiffness of the material. The core layer of the film is preferably made up of a molecularly-oriented thermoplastic polymer. The core layer is fusible to each of the surface layers. Preferably, the core layer is compatibly bonded to each of the surface layers between their contiguous surfaces. Further, the surface layers may have a softening temperature, or melting temperature, lower than that of the core layer. Exemplary materials for the core layer include polyolefins such as polypropylene, polyethylene, polyester such as polyethyleneterephthalate and polyamides such as nylon 6 or nylon 6-6. Preferably, the core layer is polypropylene or polyethylene, most preferably polypropylene. The core layer may account for about 50-99 wt. % of the film and the surface layers may account for about 1-50 wt. % of the film. The core layer and surface layers may be made up of the same class of materials to provide an advantage with regard to recycling, as the core layer may include production scrap.

In a preferred embodiment wherein the core layer is composed of polypropylene, the surface layers are preferably a copolymer of propylene and ethylene or an alpha-olefin, including random copolymers of propylene-ethylene.

By way of example only, and not limitation, one thermoplastic composite material that is particularly preferred is that marketed by Milliken & Company under the trade designation TEGRIS® LM. TEGRIS® LM is a polypropylene tape yarn having a highly-drawn core for strength with a lower melt polymer matrix for composite processing. In addition, the propylene tape yarn is fully recyclable and safer to handle than glass-filled composites of the prior art.

In a further preferred embodiment, the composite is a mat fabric woven from strips of the above designed film. The mat fabric preferably includes a multiplicity of warp strips of the film running in the warp direction of the mat fabric. The warp strips may be interwoven with fill strips running in the fill direction in transverse relation to the warp strips.

Such composites preferably exhibit a biaxial orientation of interwoven, highly oriented core layers which are securely held within a matrix of fused surface layers

In another embodiment, a multiplicity of non-olefin fiber elements may be disposed at least partially across the thickness dimension of the mat structure such that at least a portion of the fiber elements project outwardly from the mat structure. The projecting portions thus define at least a partial surface covering of non-olefin character across the mat structure. The non-olefin fiber elements are preferably anchored in place relative to the mat fabric by the formation of stitches and/or through fusion bonding within the matrix of the mat fabric.

The thermoplastic composite is introduced into a mold having the defined shape of an automotive body part. The mold may then be fitted in a vacuum bag and the vacuum bag then placed into a pressure vessel, such as an autoclave. High pressure is then applied together with heat in order to cure the body part.

A vacuum is applied wherein the pressure in the pressure vessel is adjusted to be between from about 1 to about 6 bar. The temperature in the pressure vessel is adjusted to be between 250° F. and 290° F., preferably between from about 280° F. to about 285° F. Typically, the pressure vessel is subjected to such temperatures for a time between from about 10 minutes to about 2 hours.

The pressure and temperature is maintained in the pressure vessel until such time that the thermoplastic composite is hardened. The temperature in the pressure vessel is then reduced to at least 120° F. and the pressure in the pressure vessel is also reduced. The body part having the defined shape of the mold is then removed from pressure vessel and is then released from the mold. The process described herein renders a recyclable energy absorbing matrix system, referred to by the acronym R.E.A.M.S. The resulting product has the stiffness and structural capability required for racing cars.

The method of manufacturing automotive body parts as defined herein provides for body parts, such as panels, which are not distorted. The process may be used to make other products requiring a lightweight frame, such as canoes, wake boards, safety helmets and body armour.

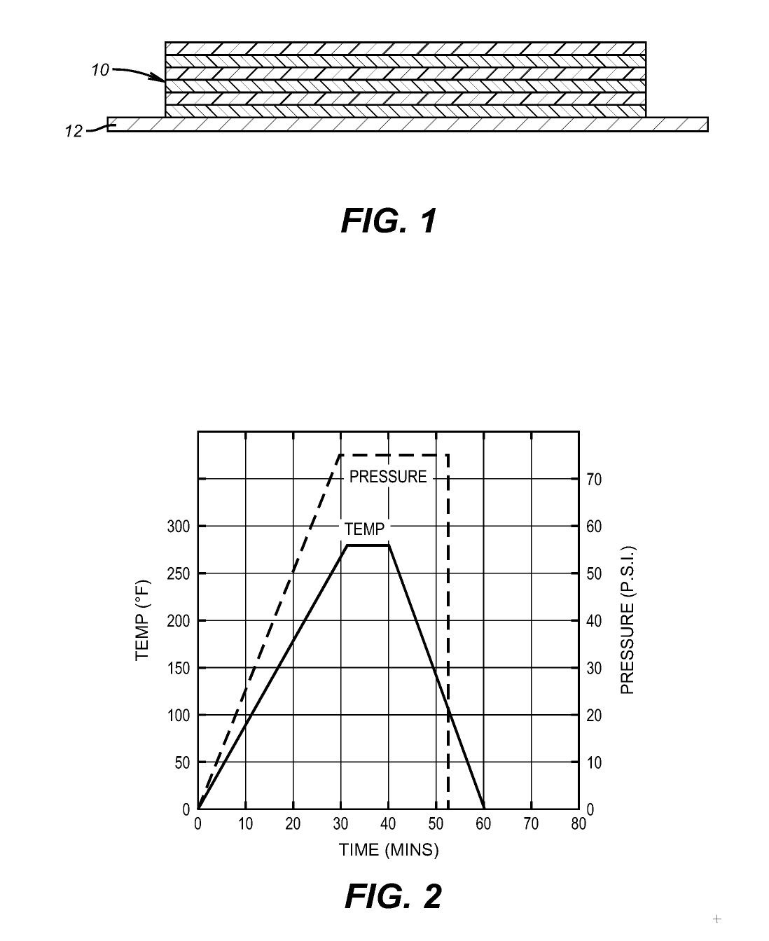

FIG. 1 shows an embodiment of the invention wherein the thermoplastic composite is composed of a plurality of thermoplastic composite layers 10, particularly polypropylene composite layers. Exemplary automotive body parts that may be prepared in accordance with the embodiment of FIG. 1 are side impact protection systems. The curing cycle described herein for production of the side impact protection system is set forth in FIG. 2. The representative curing cycle of FIG. 2 (and the other representative curing cycles described herein) provide the requisite levels of heat and pressure to effectuate the curing of the polymer and negate the high shrinking characteristics of the plastic.

The surface structure of the thermoplastic composite provides secure bonding to an adhesive or non-adhesive release layer or bonding layer (as defined herein) when placed into contact with each other. Suitable bonding layers include epoxy resins, such as bisphenol epoxy resins, phenolic/polyvinyl butral resins and other resins heat curable below the melting point of the composite. A preferred bonding layer is AF 250, an epoxy resin commercially available from Milliken & Company. While only one layer of bonding film may be introduced into the mold, preferred results are seen when two or more layers of bonding film are used.

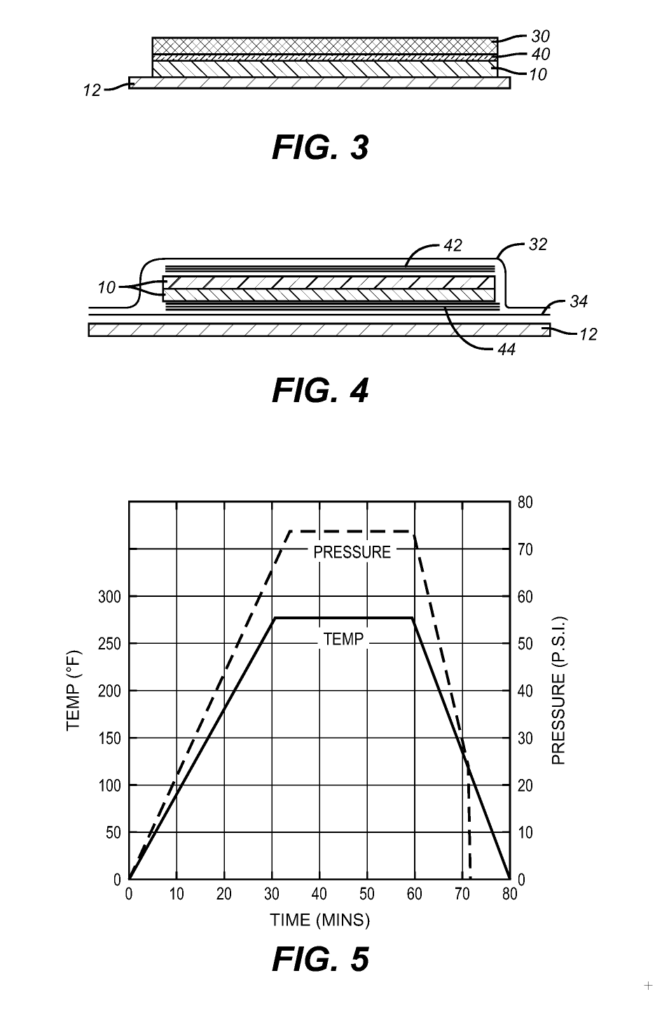

An advantage of the method of the invention is the ability to incorporate carbon fibers, graphite and other reinforcing materials into a molded article containing a thermoplastic composite. By impregnating a carrier resin, such as epoxy resins, with such reinforcing materials and introducing a bonding layer in between the impregnated carrier and the thermoplastic composite, the reinforcing materials become fused with, consolidated within or amalgamated into a matrix of the thermoplastic polymer and carrier resin based fibers during the curing cycle. FIG. 3 shows the arrangement, within the mold 12, prior to curing, after introduction of the carrier resin 30, bonding layer 40 and thermoplastic composite 10 and prior to curing. FIG. 4 shows the pre-curing arrangement within the mold of two carrier resin impregnated layers 32 and 34. As illustrated, bonding layers 42 and 44 are applied to each side of the thermoplastic composite 10 and is positioned between the carrier resin impregnated layer and the thermoplastic component. Upon curing, a matrix is formed wherein the fibers are consolidated within, fused together or amalgamated into a matrix containing the cured thermoplastic polymer. FIG. 5 illustrate a representative cure cycle for producing a conformed article which contains, in addition to the thermoplastic composite, a resin carrying the reinforcing material. The curing cycle requires a dwell time within the mold of about 30 minutes prior to application of threshold temperature and pressure conditions. Further, in FIG. 5, the representative curing cycle provides the requisite pressure for holding the thermoplastic composite against the molded surface without restricting the mobility of the fibers during the curing process. It is necessary that the reinforcing materials, during curing, be mobile in order to ensure consolidation of the materials into the final cured article.

In an embodiment of the invention a core panel may be used to provide high stiffness, high strength and energy-absorbing characteristics to the molded body part. The core typically has a thickness of from about 0.005 inches to about 1.0 inch. The core may be formed from conventional materials including balsa, fiberglass, porous sheets (such as foamed synthetic resin materials, like polyurethane foam), aluminum, stainless steel, titanium foils, glass fabric, graphite fabric and honeycomb materials. The core may further be reinforced. Honeycomb materials are more preferred because of their increased load carrying and strength properties

The core panel is preferably high strength though lightweight closely-packed honeycomb-shaped structure (which may be flexible or rigid). Preferred honeycomb materials are those characterized by alternating single-walled and double-walled geometric cells, which enable the structure to be more highly resilient, higher strength and lightweight. Suitable cells may be any geometric shapes but typically are hexagonal, circular, elliptical, triangular, square, rectangular, pentagonal or octagonal.

Suitable honeycomb materials may include polyamides a metal such as aluminum and resin-impregnated papers, such as polyamide-impregnated papers. Particularly preferred honeycomb structures are aramid fibers and phenolic resin matrix materials. Typically, the honeycomb material consists of “NOMEX paper” (a product of DuPont), which has been impregnated with a phenolic resin. Such honeycomb materials may be obtained from Hexcel, Plascore, etc. Other suitable honeycomb materials further include those referenced in U.S. Pat. Nos. 4,569,884; 5,338,594; 6,117,518; and 6,261,675, all of which are herein incorporated by reference.

When used, the surface of the core opposite the first applied thermoplastic composite is contiguous with either a second bonding film or outer skin. The second bonding film is often used when a second layer of thermoplastic composite is desired. The thickness of each of the layers may be varied for purposes of reinforcement or rigidity.

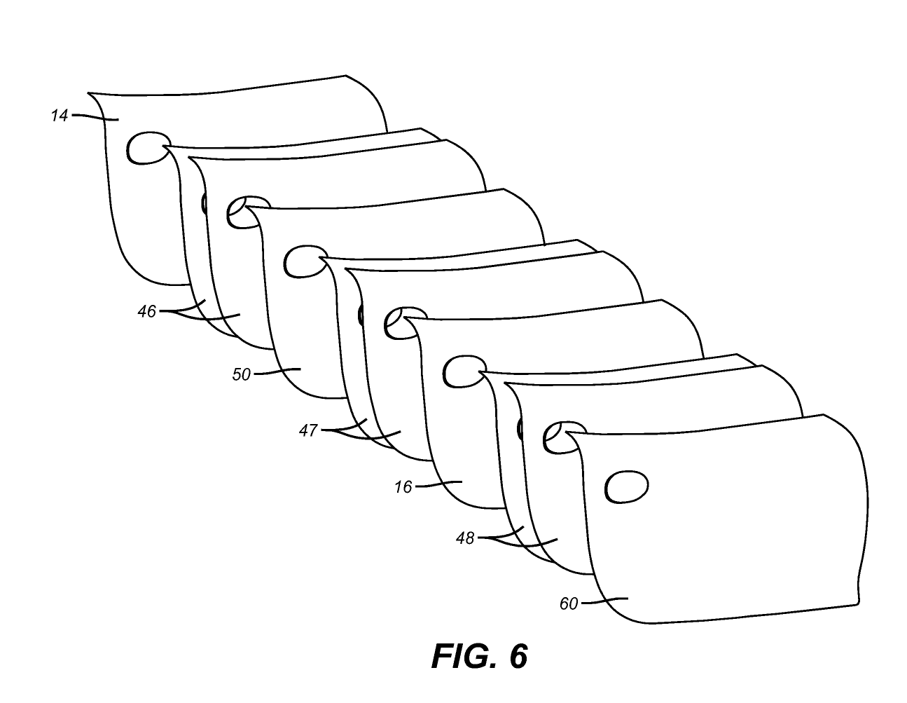

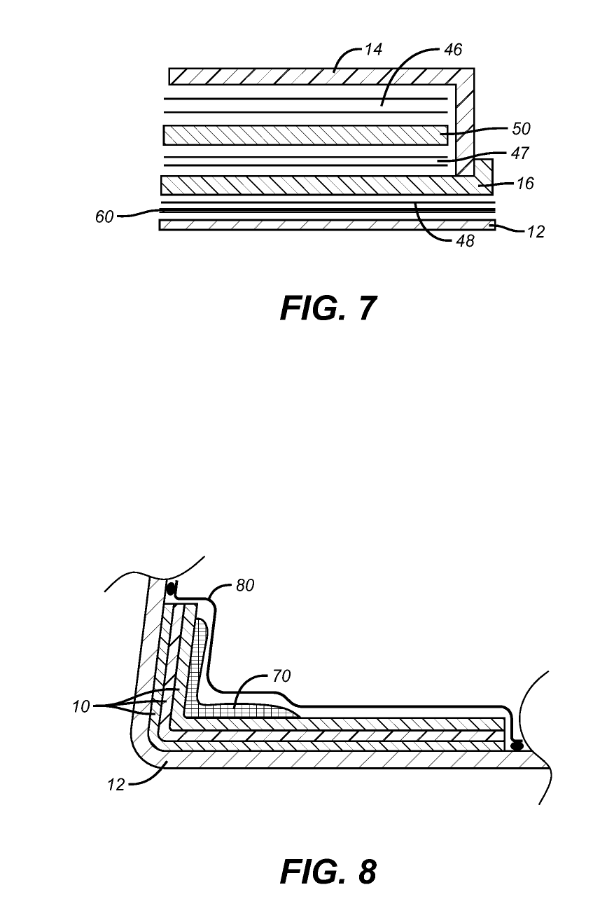

Referring to FIGS. 6 and 7, the layers introduced into the body mold, after introduction of the first thermoplastic composite 14 is bonding film 46, core 50, bonding film 47, (second) thermoplastic composite 16 and outer skin 60. Further layers of bonding films, core materials and thermoplastic materials may be placed into the mold prior to the introduction of the outer skin. Note for instance bonding layer 48. The number of layers may be varied for purposes of reinforcement or rigidity.

Typically, the outer skin has a thickness of from about 0.001 to about 0.034 inches. The outer skin functions as a release layer. Exemplary outer skins are carbon fiber/epoxy prepregs. The outer skins are normally applied as tapes, fabrics or prepregs (or pre-impregnated materials). Specific examples of prepegs include carbon fiber/epoxy prepregs, available from Cytec. Further exemplary outer skins include fluorocarbons such as fluorinated ethylene-propylene (FEP), silicones, polyamides, polyketones like polyaryletherketones, polyphenylene sulfide and polyethyleneimine. The durability of the outer skin permits finishing the body frame to be mechanically or manually treated, such as sanding, to provide smooth surfaces and cosmetic treatments such as a primer or paint.

Prior to application of the vacuum, a thermo expanding intensifier may be introduced into bag 80. Suitable thermo expanding intensifier 70 is a silicon mandrel plug, fiberglass or a ferrous material. This is set forth in FIG. 8.

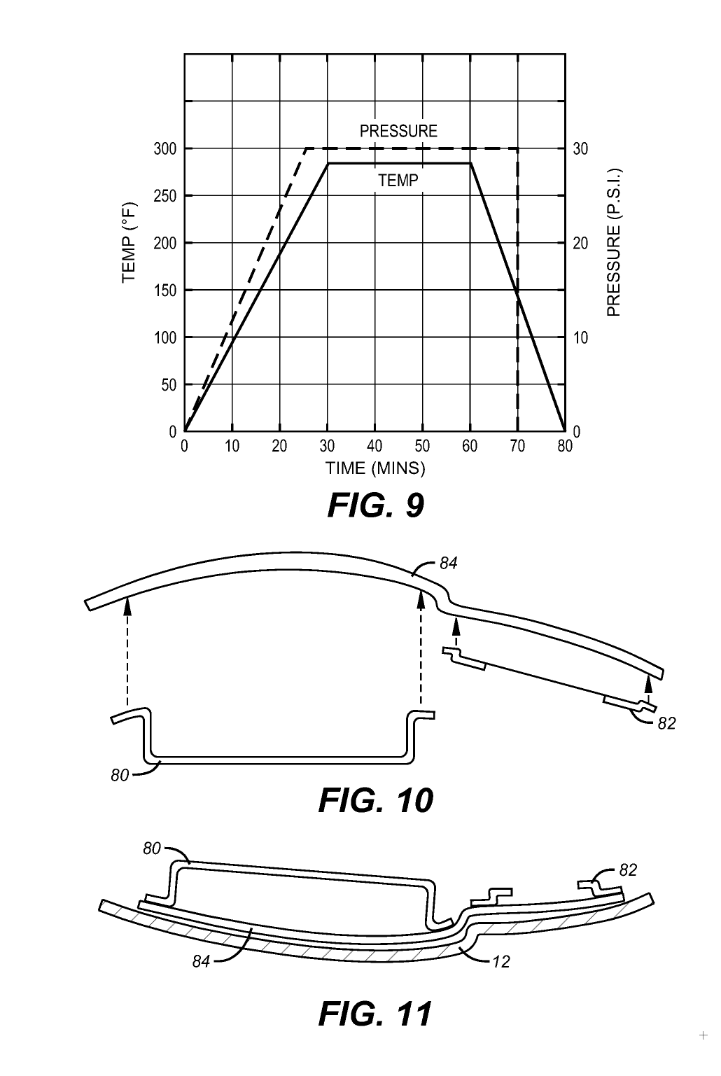

The temperature and pressure conditions described above for the side impact protection system are also used in the manufacture of body panels and other components which employ a bonding layer, outer skin layer, core, etc. FIG. 9 is a representative curing cycle for the manufacture of such components. Note the difference between FIG. 9 versus the cure cycle in FIG. 5 used to manufacture an automotive body part which contains, in addition to the thermoplastic composite, a reinforcing material, such as carbon or graphite fibers. The representative cure cycle in both FIGs. effectuates consolidation of the thermoplastic composite with other components (such as core and/or fibers, etc.) which may be present in the molded article.

In the manufacture of a vehicle, different molds will be used for the different shapes of the body parts of the vehicle. The process described herein will be suitable for any mold design desired. Once body parts from two or more molds have been released, the hardened body parts may then be placed into an assembly mold. The process described herein may then be applied to the components within the assembly mold. FIG. 10 illustrates a body part manufactured from three different molds. FIG. 11 shows placement of each of the three pre-formed body parts 80, 82 and 84 into the assembly mold. Thus, once the pre-formed panels have been introduced into the assembly mold, the assembly mold may then be introduced into a vacuum bag and the vacuum bag then is introduced into a pressure vessel. The pressure vessel is then subjected to pressures between from about 1 to about 6 bar and a temperature less than about 285° F. for a time sufficient to soften the pre-formed body panels. The preformed body panels are then hardened to form the assembled component. The assembled component has the shape of the assembly mold. Following a reduction in temperature and pressure, the assembled body part is removed from the mold and the resulting assembled body part is then released from the mold.

The foregoing disclosure and description of the invention is illustrative and explanatory thereof, and various changes in the size, shape, and materials, as well as in the details of illustrative construction and assembly, may be made without departing from the spirit of the invention.

What is claimed is:

1. A method of manufacturing a body part for an automotive vehicle having a defined shape which comprises:
(a) introducing into a mold having the defined shape of the body part at least one layer of a thermoplastic composite;
(b) enclosing the mold in a vacuum bag;
(c) inserting the vacuum bag into a pressure vessel;
(d) subjecting the pressure vessel to a pressure between from about 1 to about 6 bar and a temperature less than about 285° F. for a time sufficient to harden the thermoplastic composite, thereby forming the defined shape of the body part;
(e) decreasing the temperature to less than or equal to 120° F. and then reducing the pressure in the pressure vessel;
(f) removing the body part having the defined shape from the pressure vessel; and
(g) releasing the body part of defined shape from the mold.

2. The method of claim 1, wherein the thermoplastic composite is a polypropylene composite.

3. The method of claim 1, wherein the body part is a side impact protection system for an automotive vehicle.

4. The method of claim 1, wherein at least one layer of a bonding film is further introduced into the mold in step (a) after introduction of the thermoplastic composite.

5. The method of claim 4, wherein the bonding film is an epoxy resin.

6. The method of claim 5, wherein the epoxy resin is impregnated with fibers.

7. The method of claim 4, wherein at least one layer of substrate material is introduced into the mold after introduction of the bonding film.

8. The method of claim 7, wherein a second bonding film is introduced into the mold after introduction of the at least one layer of substrate material.

9. The method of claim 8, wherein a second polypropylene thermoplastic composite is introduced into the mold after introduction of the second bonding film.

10. The method of claim 9, wherein a surface film is introduced into the mold after introduction of the second polypropylene thermoplastic composite.

11. The method of claim 1, wherein the polypropylene thermoplastic composite comprises axially drawn tape fibers.

12. The method of claim 11, wherein the polypropylene thermoplastic composite comprises a mat having a plurality of layers of axially drawn tape fibers.

13. The method of claim 12, wherein the polypropylene thermoplastic composite further comprises embedded fiber elements in the mat.

14. The method of claim 1, wherein the pressure vessel is subjected to a temperature between from about 280° to about 285° F.

15. The method of claim 14, wherein the pressure vessel is subjected to a temperature between from about 280° to about 285° F. for a time between from about 10 minutes to about 2 hours.

16. The method of claim 1, wherein steps (a) through (g) are repeated at least one time using a mold having a defined body shape which is different from the defined shape of the body part of step (a).

17. The method of claim 16, further comprising:
(i) introducing into an assembly mold each of the released body parts having different defined shapes;
(ii) enclosing the defined assembly mold in a vacuum bag;
(iii) introducing the defined assembly mold into a pressure vessel;
(iv) subjecting the pressure vessel to a pressure between from about 1 to about 6 bar and a temperature less than about 285° F. for a time sufficient to soften and then harden the thermoplastic composite, thereby forming an assembled body part having the defined shape of the defined assembly;
(v) decreasing the temperature in the pressure vessel to less than or equal to 120° F. and then reducing the pressure in the pressure vessel;
(vi) removing from the pressure vessel an assembled body part having the shape of the defined assembly mold; and
(g) releasing the assembled body part having the defined shape of the defined assembly mold from the mold.

18. The method of claim 1, wherein prior to application of the vacuum in step (d), a thermo expanding intensifier is introduced into the bag.

19. The method of claim 18, wherein the thermo expanding intensifier is a silicon mandrel plug, fiberglass or a ferrous material.

20. A method of manufacturing a body part having a defined shape which comprises:
(a) introducing into a mold of a defined shape at least one layer of a polypropylene thermoplastic composite;
(b) enclosing the mold in a vacuum bag;
(c) inserting the vacuum bag into a pressure vessel;
(d) subjecting the pressure vessel to a pressure between from about 1 to about 6 bar and a temperature less than about 285° F., wherein the pressure is at least 1 bar when the temperature is 80° F., and maintaining the pressure and temperature in the pressure vessel for a time sufficient for the thermoplastic composite to harden and form a body part having the defined shape of the mold;
(e) decreasing the temperature to less than or equal to 120° F. and then reducing the pressure in the pressure vessel;
(f) removing the body part having the defined shape from the pressure vessel;
(g) releasing the body part of defined shape from the mold;
(h) optionally repeating steps (a) through (g) at least once using a mold having a defined shape which is different from the defined shape of the mold of step (a);
(i) introducing the released body parts of steps (f) and (h) into an assembly mold having a defined shape;
(j) enclosing the assembly mold in a vacuum bag;
(k) inserting the vacuum bag of step (j) into a pressure vessel;
(l) subjecting the pressure vessel to a pressure between from about 1 to about 6 bar and a temperature less than about 285° F. for a time sufficient to soften and then harden the thermoplastic composite, thereby forming an assembled body part having the defined shape of the defined assembly mold;
(m) decreasing the temperature in the pressure vessel to less than or equal to 120° F. and then reducing the pressure in the pressure vessel;
(n) removing an assembled body part having the defined shape of the defined assembly mold from the pressure vessel; and
(o) releasing the assembled body part having the defined shape of the defined assembly mold from the mold.

21. The method of claim 20, wherein at least one layer of an epoxy resin material is further introduced into the mold in step (a).

22. The method of claim 21, wherein the body part is a side impact protection system.

23. The method of claim 20, wherein the polypropylene thermoplastic composite comprises axially drawn tape fibers.

24. The method of claim 23, wherein the composite comprises a mat having a plurality of layers of axially drawn tape fibers.

25. The method of claim 24, wherein the epoxy resin is embedded with fibers.

26. The method of claim 1, wherein the body part is an automotive body part.

27. The method of claim 20, wherein the body part is an automotive body part.
